(19) United States
(12) Patent Application Publication
(10) Pub. No.: US 2009/0248478 A1
(43) Pub. Date: Oct. 1, 2009

(54) Frequency-Aware Spot Selection for Content Campaigns

(75) Inventors: Jagpreet S. Duggal, Seattle, WA (US); Robert D. Gardner, Irvine, CA (US); Deepak Chandra, Irvine, CA (US); Neil C. Rhodes, Redlands, CA (US); Bozhena Bidyuk, Westminster, CA (US); Alexandr Y. Smolyanov, Rancho Santa Margarita, CA (US); Richard Maher, Newport Beach, CA (US); Weizhao Wang, Irvine, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/412,153

(22) Filed: Mar. 26, 2009

Related U.S. Application Data
(60) Provisional application No. 61/040,121, filed on Mar. 27, 2008.
(60) Provisional application No. 61/039,781, filed on Mar. 26, 2008.

(51) Int. Cl. G06Q 30/00; G06Q 99/00

(52) U.S. Cl. 705/8; 705/14; 705/26

(57) ABSTRACT

A computer-implemented method including receiving advertising campaign characteristics with a minimum frequency target for an advertising campaign; selecting, based on the received advertising campaign characteristics, a station having one or more advertising spots available; determining, based on the one or more advertising spots, whether the minimum frequency target is attainable for the selected station; and making an offer to the selected station, in response to the determination, to obtain advertising for the advertising campaign.

This application claims the benefit of U.S. Provisional Application No. 61/039,781, filed Mar. 26, 2008, and U.S. Provisional Application No. 61/040,121, filed Mar. 27, 2008, which are incorporated by reference.

### TECHNICAL FIELD

This disclosure generally relates to content distribution.

### BACKGROUND

Advertisements (“ads”) can be included in various forms of broadcast media. For example, radio can be a powerful broadcast medium for advertisers to achieve their goals for a given advertising campaign. Additionally, radio advertising can increase online brand awareness, and be a cost effective way to reach a targeted audience. For example, an advertiser can target consumers with a specific lifestyle and demographics by selecting the station types, locations, and dayparts. Advertisers can book advertising campaigns with multiple broadcasters through an ad intermediary. Advertisers can specify criteria that the intermediary can use to book advertising spots for the advertising campaigns.

### SUMMARY

This specification describes various aspects relating to content distribution including methods that include booking advertising campaigns through a spot selection process that maximizes reach while satisfying the desired campaign frequency. For example, the spot selection process can take into account the campaign frequency goals into its cost calculations. While campaign budget is assumed to be a hard constraint, i.e., the spot selection process will not book ads associated with the campaign that exceed the campaign's budget, other constraints like frequency, market, tier, daypart, and day of the week weightings can be treated as soft constraints with, for example, a decreasing order of priority. In this manner, one or more features (e.g., the campaign frequency goals) can be treated as a more important constraint than the others (e.g., campaign distributions including distribution of impressions by market, ranking of a particular station, dayparts, or day of the week).

In one implementation, the described subject matter in this specification can be a computer-implemented method including receiving advertising campaign characteristics including a minimum frequency target for an advertising campaign; selecting, based on the received advertising campaign characteristics, a station having one or more advertising spots available; determining, based on the one or more advertising spots, whether the minimum frequency target is attainable for the selected station; and making an offer to the selected station, in response to the determination, to obtain advertising for the advertising campaign. Other implementations of this aspect include corresponding systems, apparatus, and computer program products.

These and other implementations can optionally include one or more of the following features. The received advertising campaign characteristics can implicitly include the minimum frequency target. The received advertising campaign characteristics can include information regarding the advertising campaign having recently advertised on the station. The selected station can include a radio station. The selected station can include a television station. Selecting can include selecting the station that serves an underserved market and station-tier. Determining can include determining whether the minimum frequency target is attainable over a seven-day period. Determining can also include determining based on forecasted advertising spots. The method can include choosing, based on daypart and day of the week criteria, and proximity to present time, on which of the one or more advertising spots to make the offer.

In other implementations, the described subject matter in this specification can be a system including an advertiser-facing module configured to interface with an advertiser and to receive advertising campaign characteristics, including a minimum frequency target, for an advertising campaign; the capability to select, using the advertising campaign characteristics, a broadcast station from available broadcast stations; the capability to determine, using available advertising spots of the broadcast station, whether the minimum frequency target is attainable by the advertising campaign on the broadcast station; and the capability to submit an offer, on behalf of the advertising campaign, to the broadcast station for one or more of the available advertising spots.

These and other implementations can optionally include one or more of the following features. The broadcast station can be a television station. The system can include the capability to choose, using at least daypart and day of the week criteria, on which of the available advertising spots to make the offer.

Particular aspects can be implemented to realize one or more of the following potential advantages. Campaign frequency goals can be taken into account during a spot selection process (e.g., an auction process) for bidding on advertising spots. For example, a frequency-aware auction process can be used to purchase advertising spots for offline or traditional media (e.g., radio and television) in a branding campaign. In this manner, the systems and methods described herein can be an improvement over existing auction methodology. In addition, by incorporating frequency goals into the cost metric, computational intensive algorithms can be avoided during the spot selection process. Further, advertising spots that meet campaign frequency goals can be selected automatically to achieve an effective campaign. Thus, the system and methods described herein can maximize the reach for an advertising campaign, while maintaining budget, frequency and other distribution goals.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is a conceptual diagram showing an example overview of frequency-aware spot selection.

FIG. 2 is a conceptual diagram of an example advertising campaign showing relationships between various advertising components.

FIG. 3 is a schematic diagram of an example system for selecting advertising spots for an advertising campaign.

FIG. 4 is a flow chart illustrating an example frequency-aware spot selection for an advertising campaign.

FIG. 5 is a flow chart illustrating an example process for selecting broadcasters based on campaign frequency goals.

FIG. 6 is a flow chart illustrating an example process for obtaining advertising spots for a selected broadcaster based on campaign frequency goals.

FIG. 7 is a block diagram of an example computing device and system used to implement the advertising campaign booking system.

Like reference symbols in the various drawings indicate like elements.

### DETAILED DESCRIPTION

In offline or traditional media (such as radio and television) the concept of reach and frequency can be critical to the way advertising campaigns are booked. Reach and frequency are campaign metrics that can be used to measure the effectiveness of an advertising campaign. For example, in a broadcast radio context, “reach” is an estimate of the number of unique listeners who hear an ad at least once during a given schedule. “Frequency” is an estimate of the average number of times each listener hears the advertisement during a given schedule. “Impressions” (ω) can be approximately calculated as the product of reach (ρ) and frequency (v).

ω≈ρ×v

An impression is the presentation (e.g., audibly or visually) of an ad to an audience member.

Conventional marketing wisdom states that there are optimal combinations of reach and frequency that can lead to an effective campaign. Ideally, an advertising campaign needs to reach as many people as possible while still ensuring that each listener/viewer is exposed to the advertisement a sufficient number of times (e.g., more than once) to achieve the desired exposure (e.g., brand awareness). For example, a listener/viewer may need to transition through the stages of awareness and interest before eventually taking an action (e.g., by purchasing the advertised product). Such a transition may require multiple exposures to an advertisement. The optimal frequency can depend on the medium (e.g., an optimal television campaign emphasizes reach while an optimal radio campaign emphasizes frequency) and the type of campaign. In addition, different types of campaigns (e.g. direct response, brand building, brand maintenance, etc.) can have different optimal reach and frequency.

An audience is reached by an ad when the ad is delivered to the audience. Stations deliver ads to audiences. “Stations” can include traditional broadcasters, such as broadcasting stations (i.e., stations equipped to broadcast radio or television programs), as well as online broadcasters (i.e., entities communicating via the Internet and other networks).

The ad delivering capacity of a station can be divided into spots. For example, a spot can be defined by a relationship of a given time period to a given station (e.g., Oct. 1, 2008, 11:12:00-11:12:30 AM, on the American Broadcasting Company (ABC) network). An advertiser can schedule, or book, a spot so that an ad from the advertiser's campaign is delivered in the spot.

Advertisers can pay for spots based on prices determined by stations. Based on the price and reach of a given spot, a cost per mile (CPM), or cost per thousand impressions, can be calculated.

In general, an advertising campaign can include characteristics, such as criteria for target markets, station tiers, demographics, dayparts, and days of the week, and type of campaign (e.g. direct response, brand building, or brand maintenance). In addition, an advertising campaign can be broken into flights. A “flight” is a sub-campaign or a predetermined time period within a campaign having specific goals.

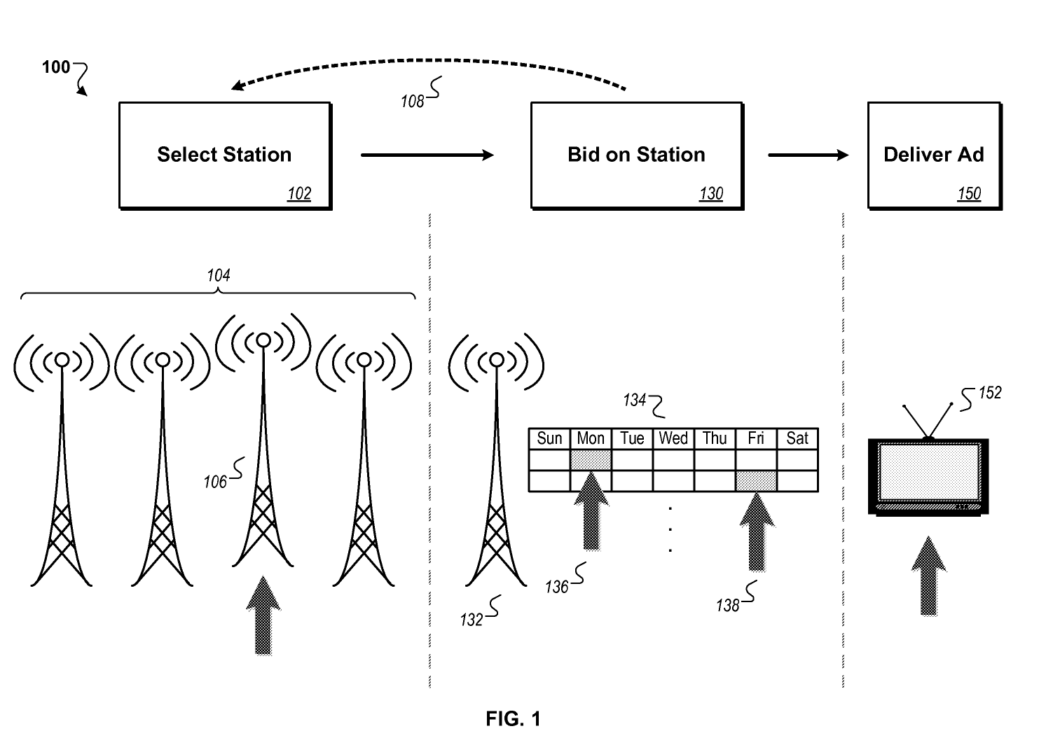

FIG. 1 is a conceptual diagram showing an example overview of frequency-aware spot selection. In general, spots are selected for an advertising campaign by, potentially iteratively, selecting a station and then bidding on the selected station's available spots. A spot selecting operation can perform the selection of the station and the station's spots, and bidding on the spots. If a bid is successful, at the appropriate time or place, a campaign ad is delivered to the station audience.

Whether a bid is successful can depend on the scheduling model used. A reservation model provides a price for a spot. The price can be for a given day. An advertiser can reserve the spot by bidding (i.e., offering) the price. In an auction model, advertisers can bid on a given spot and a successful bidder can be selected from those advertisers who are bidding. The selection of the successful bidder can involve various criteria (e.g., bid amount and ad quality).

For a reservation campaign, a spot selecting operation can optimize frequency on a week-by-week basis. This can be accomplished by examining the campaign on a flight-week by flight-week basis. The spot selecting operation can use overall distribution measurements and either overall frequency metrics or a new frequency metric for each week.

For an auction campaign, a spot selecting operation can pre-seed the frequency metric with information for the spots that have run so far in a current flight week. The spot selecting operation can select spots from the current day and projected spots available for the rest of the flight week thus allowing a more global view of inventory when making bidding decisions. The spot selecting operation can determine bid amounts by bidding slightly over the historical price of the spot.

For simultaneous ascending auctions, the selecting can be similar to selecting for a reservation campaign. The spot selecting operation can have prices for the current day and projected prices for the remainder of the flight week. The spot selecting operation can be oblivious to multiple rounds of the auction taking place. The spot selecting operation can simply select a subset of spots given the available spots and prices.

In some implementations, the spot selecting operation adheres to certain general guidelines. For example, with an auction campaign, achievement of minimum frequency target cannot generally be guaranteed. However, the disclosed subject matter can increase the chances of achieving campaign minimum frequency targets. If a campaign is the highest bidder in an auction for an entire week, the spot selecting operation can employ additional measures to help the campaign meet minimum frequency targets, provided adequate inventory is available. The spot selecting operation can weigh a minimum frequency target more heavily than distribution criteria (e.g., requested daypart). In doing so, the spot selecting operation can avoid clustering campaign spots on a single day and daypart.

In some implementations, the goal of the spot selecting operation can be to maximize a campaign's reach while maintaining budget, frequency and other distribution goals. To that end, the spot selecting operation can have absolute and target constraints, based on campaign criteria, when selecting spots for the campaign. For example, budget can be an absolute constraint. However, the spot selecting operation can weight target constraints the same or differently as part of the selecting. For example, targets related to frequency, market, station tier, daypart, and day of the week can be weighted distinctly and in descending order.

Referring to FIG. 1, the spot selecting operation selects 102 a station. A set of stations 104 is available for selection by the spot selecting operation. The spot selecting operation is able to access inventory, or listings of available spots, for the set of stations 104. The set of stations 104 can be radio broadcast stations, television broadcast stations, online advertising stations, or a combination of station types. Based on the evaluation of the set of stations 104, the spot selecting operation selects 102 a particular station 106.

To select 102 a station, some implementations of the spot selecting operation can rely on certain assumptions. For example, if a campaign has recently won spots for a given station-daypart combination, the campaign may be more likely to win spots at present for the same station-daypart combination. Conversely, if a campaign has recently lost a bid for a station-daypart combination, the campaign may be less likely to win spots at present for the station-daypart combination. Some implementations also assume that there is negligible overlap between station audiences. Evidence indicates that for the majority of cases overlap between stations is negligible. Thus, in these implementations, the spot selecting operation need not consider station overlap when calculating a campaign's frequency. The spot selecting operation can attempt to reach a campaign's target frequency for each station bid upon.

The selection 102 of the station depends on characteristics of the campaign. The characteristics can include weightings for various metrics and campaign criteria. Metrics are calculated based on the criteria and information for the candidate station. The spot selecting operation can greedily choose stations by thus evaluating stations based on the weightings and metrics.

Campaigns can include weightings for cost, market distribution and rank level distribution metrics. Where campaigns include distribution criteria, such as particular days or dayparts, target demographics, or rank level (e.g., based on Arbitron® or Nielsen ratings), the target and actual reach can be different. Distribution metrics (δ) can be calculated using the following equation where the actual reach (ρ_{A}) is less than the target reach (ρ_{T}).

$$δ = \frac{{ρ}_{A}}{{ρ}_{T}}$$

Where the actual reach (ρ_{A}) is greater than or equal to the target reach (ρ_{T}), distribution metrics can be calculated using the following equation.

$$δ = \frac{{ρ}_{A} - {ρ}_{T}}{1 - {ρ}_{T}}$$

The distribution metrics are in the range [−1 . . . 1] where negative values imply unattractive stations, and positive values imply attractive stations.

In some implementations, the cost metric (X) is calculated using the following equation, where the station cost (X_{S}) (defined below) is less than the maximum bid (β) of the campaign.

$$X = \frac{{X}_{S}}{β}$$

Where the station cost is greater than or equal to the maximum bid, the cost metric is 0 (zero). The cost metric is a value in the range [0 . . . 1] where higher values imply more attractive stations.

The station cost (X_{S}) is calculated using the cost for enough additional spots to satisfy the minimum frequency target (v_{R}) for the station and the total impressions (ω) for all spots on the station over a given time period (e.g., a week).

$${X}_{S} = \frac{{v}_{R}}{ω}$$

The station cost does not include costs for past spots. In this way, the cost for a station having no impressions in a given time period will be much higher (all things being equal) than for a station needing only one additional spot to reach the minimum frequency target. The spot selecting operation will thus tend to choose stations where spots have already played in a given time period. In some implementations, there is no comparison from time period to time period (e.g., week-to-week). In other implementations, which provide preference for stations used regularly, the total impressions can be, e.g., for the past month or all time.

A detailed process for selecting stations is presented below. Here a general selection process is provided for some implementations. The spot selecting operation chooses a station where a campaign has the highest chances of achieving the minimum frequency target. The spot selecting operation also tries to maintain market and tier distributions by creating groupings for each market and tier. All target stations of a campaign go into one of these groupings. A special grouping contains all the stations on which the campaign has recently won spots. The spot selecting operation first selects stations from this grouping and after there are no more stations in the grouping moves to other groupings.

The spot selecting operation keeps track of impressions by market, tier, daypart, and day of the week as spots are selected. The spot selecting operation uses the tracked impressions in deciding from which grouping to select, first selecting the market that is most underserved in terms of impressions. The spot selecting operation uses a market weighting and the tracked impressions to make the selection. After deciding on the market, the spot selecting operation then selects the tier that is most underserved in that market. The spot selecting operation picks the next station from the selected market and tier.

The spot selecting operation sorts the stations in each grouping by whether the campaign has recently bid on the station and lost, or has no recent history. When selecting a station, the spot selecting operation first picks stations that have no history over stations where the campaign has lost recently. Within each category (i.e., “recently lost” or “no history”) stations are sorted by efficiency (i.e., target CPM). The time period used in determining the categories can be a configurable parameter (e.g., a day, a week, a month, or a year).

Once a station is selected 102, the spot selecting operation bids 130 on spots of the selected station 132. The selected station 132 can be the selected station 106 or another station selected 102 on a subsequent iteration. For example, based on an inventory 134 of the selected station 132, the spot selecting operation can select two spots 136 and 138 on which to bid and determine bids for the spots.

A campaign's reach often increases rapidly with the first few spots on a selected station 132, but additional spots can provide minimal increases in reach. Thus, a point of diminishing returns can exist after which selecting additional spots on the selected station 132 will have minimal effect on the campaign's reach. Therefore, in some implementations, the spot selecting operation selects only enough spots to reach the minimum frequency target on the selected station 132, before quitting or moving 108 to another station.

In bidding 130 on a station, the objective of the spot selecting operation is to determine the number of spots on which to bid to achieve the minimum frequency target for the selected station 132. To make the determination, the spot selecting operation examines the spots previously won by the campaign. The spot selecting operation may also consider forecasts of spots to be available.

The spot selecting operation can select the spots on which to bid by weighting various aspects of the spots given the campaign characteristics. In some implementations, spots are selected by a weighted sum of a cost metric and distribution metrics. Distribution metrics are defined similarly for spots as for stations (discussed above). The cost metric (X) can be calculated using the following equation, where the spot CPM (X_{M}) is less than the campaign's maximum bid (β).

$$X = \frac{{X}_{M}}{β}$$

Where the spot CPM is greater than or equal to the maximum bid, the cost metric is zero.

As each spot is chosen, the spot selecting operation can calculate the frequency achieved so far. Once the minimum frequency target has been achieved, the spot selecting operation can stop selecting spots for the selected station 132. In addition, after each spot is selected, the spot selecting operation can update the daypart and day of the week distributions. Using this information, the spot selecting operation can often guarantee meeting frequency targets although distribution criteria are met where possible. The spot selecting operation can choose stations without considering daypart and day of the week distributions but once a station is selected 132, the spot selecting operation can use the distribution criteria in selecting spots across a flight.

Another objective of the spot selecting operation can be to achieve the minimum frequency target for each given running period. For example, the running period can be a week, or any seven consecutive days of the campaign on a station. If the spot selecting operation cannot achieve the minimum frequency target for all running weeks, the spot selecting operation can attempt to achieve the minimum frequency target for as many running weeks as possible. If the minimum frequency target cannot be achieved for any running week, the spot selecting operation can forego bidding on any spots of the station.

To achieve the minimum frequency target for as many weeks as possible, the spot selecting operation can consider the campaign's frequency for spots over the last six days. The spot selecting operation can then determine whether bidding on some or all of the spots for the current day will be sufficient to achieve the minimum frequency target for the week. If not, the spot selecting operation can consider campaign spots for the last five days, the available spots for the current day and forecasted spots for the next day. The spot selecting operation can thus iteratively shift one day at a time looking further into the future to determine whether the minimum frequency target can be achieved with the given station.

Once a window is found in which the frequency target can be met, the spot selecting operation can decide on which spots to bid. The spot selecting operation can create daypart-day of the week groupings for the current day's available spots and forecasted spots for upcoming days, if necessary. In some implementations, the spot selecting operation can prioritize the selection of spots based on proximity to the present. The spot selecting operation can also keep track of the impressions delivered during particular dayparts and days of the week to use in determining which spots to bid on in the future, according to campaign criteria.

In some implementations, the spot selecting operation can first select a spot grouping before selecting spots from the grouping. To pick a grouping, the spot selecting operation can first determine the target daypart that is the most underserved and then the day of the week in that daypart which is most underserved.

The spot selecting operation can continue picking spots from the selected station 132 until the minimum frequency target is met, the campaign's budget is expended or the station has no more spots to select. If the campaign budget runs out before the minimum frequency target is reached, the spot selecting operation can disregard spots selected for bidding for the selected station. The spot selecting operation can attempt to reach the minimum frequency target by selecting another station.

In some implementations, the spot selecting operation does not guarantee any daypart or day of the week distributions but employs a best-effort strategy. The spot selecting operation may continue bidding on other days or dayparts even if target days or dayparts are not available.

After bidding on spots of the selected station 130, the spot selecting operation can potentially 108 select another station 102 for which the campaign's minimum frequency target can be reached. The spot selecting operation can thus maximize the reach of a campaign by selecting as many stations as possible while maintaining the minimum frequency target on each station. The spot selecting operation can attempt to satisfy campaign metric weightings across stations by updating market and rank level distributions before selecting another station. The spot selecting operation will not select another station 102 where the campaign budget has been spent or there are no more suitable stations to select.

If campaign budget still remains when no more stations remain for selection, the spot selecting operation can stop spending from the campaign budget, bids on spots for stations where the minimum frequency target has been achieved, or bids on spots for stations where the minimum frequency target can not be achieved. In some implementations, a campaign setting can indicate what action the spot selecting operation is to take in this situation.

Once a campaign has won a spot on a station, a campaign ad can be delivered 150 to an audience. For example, the delivery can be via television 152 to a viewing audience. Delivery can also be via radio, Internet or other network.

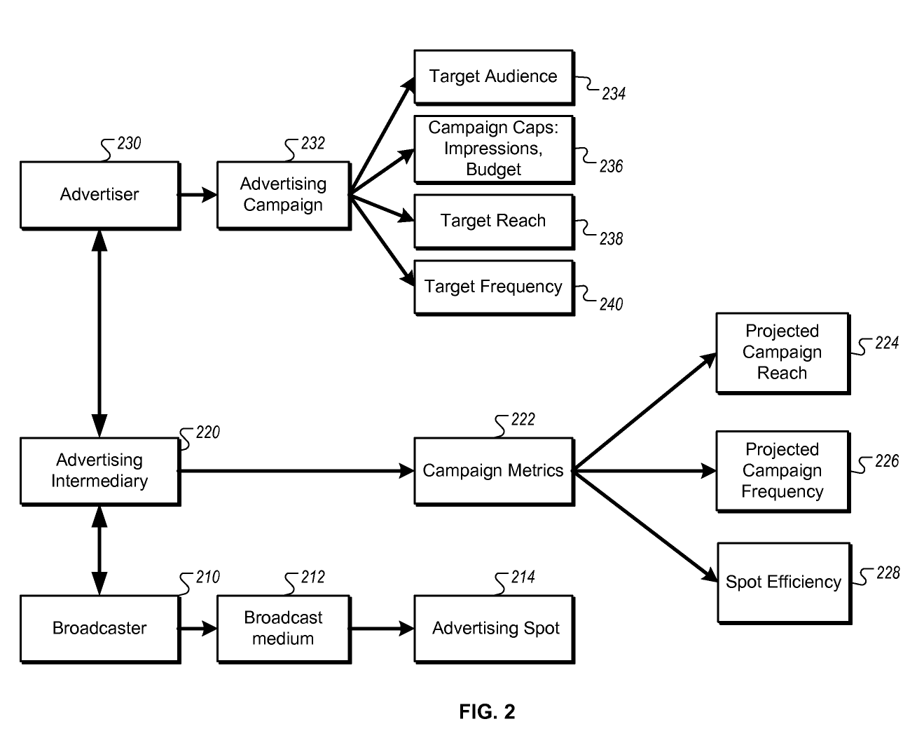

FIG. 2 is a conceptual diagram of an example advertising campaign showing relationships between various ad components. The diagram shows a broadcaster 210, which can include, e.g., a radio station, a television station, or an Internet broadcaster. The broadcaster 210 can deliver broadcast content to the audience via broadcast medium 212, which can include, e.g., radio, television, wireless communication networks or Internet broadcast media. Additionally, various advertising spots, such as advertising spot 214, can be included as part of the broadcast content. The advertising spots are time slots when ads can play during a broadcast. For example, advertising spot 214 can be a 30-second time slot of the broadcast content.

The conceptual diagram of FIG. 2 also shows an advertising intermediary 220 for serving ads. The advertising intermediary 220 can interface with and communicatively couple to the broadcaster 210 to manage (e.g., service) available advertising spots for advertising campaigns. For example, the advertising intermediary 220 can provide a price rate (i.e., spot price or rate card price) associated with advertising spot 214. The rate card price can be a function of the number of estimated audience, which can vary based on the type of broadcaster, broadcasting market (e.g., Los Angeles vs. San Diego), and broadcasting daypart (e.g., morning commute vs. evening commute).

For example, in radio advertising a commonly used measure of estimated listeners is average quarter hour (AQH) persons. The gross AQH is defined as the average number of persons (ages 12 and above) listening to a broadcast for at least five minutes of a given 15-minute period. The information on gross AQH can be provided by third-party ratings companies, such as Arbitron.

Various campaign metrics 222 can be calculated by the advertising intermediary 220. Campaign metrics 222 can include, for example, a campaign reach 224, a campaign frequency 226, a spot efficiency 228, and a CPM metric. As noted above, an impression can be defined as presentation (e.g., audibly or visually) of an ad to a member of an audience. For example, given the rate card price (X_{R}) and a gross AQH (μ_{G}) number for a spot, a gross CPM (X_{MG}) can be calculated using the following equation.

$${X}_{MG} = ( \frac{{X}_{R}}{{μ}_{G}} ) \times 1 , 000$$

For a successful advertising campaign, advertisers need to be concerned not just by how much media is consumed, as a whole, but how many people are consuming it and how often. Thus, reach and frequency information can be important for an effective advertising campaign because it answers the questions of “How many potential customers are you talking to?” and “How often do you ask them for their business?” Further, when allocating advertising spots for a campaign, it can be important to maximize reach of the campaign while keeping frequency in a preferred range. For example, it is generally known in the advertising industry that people only “hear” or “see” the ad and take action if they are actually interested in the type of service advertised. By maximizing reach, the advertiser can maximize the number of potential customers who perceive the ad.

However, the reach of the campaign cannot simply be calculated by adding up the reach for all the allocated advertising spots. This is because there can be an overlap between the demographics of two advertising spots. For example, suppose an advertising campaign has two advertising spots allocated to it. Advertising spot #1, which is scheduled to be broadcast at 9 a.m. on Monday, has a gross AQH of 10,000 listeners; and advertising spot #2, which is scheduled to be broadcast at 10 a.m. on Tuesday, has a gross AQH of 8,000 listeners. The total reach for the advertising campaign (i.e. campaign reach) can likely be a number between 10,000 and 18,000 unique listeners. The campaign reach can be closer to 10,000 unique listeners if most of the listeners overlap between the two advertising spots; on the other hand, the campaign reach can be closer to 18,000 unique listeners if very few of the listeners overlap between the two advertising spots. The degree of overlap can depend on whether the two advertising spots are broadcast by the same broadcaster, in the same market, in the same daypart, or in the same format/category.

Unlike reach, the frequency of ad play is not always maximized because it can depend on the product being advertised (e.g., a pack of chewing gum vs. an automobile) and campaign objective (e.g., branding campaign vs. direct response campaign). For example, if the person hears the ad only once, he or she may forget too easily or may hear the ad at the wrong time and not be prepared to act. Hearing the ad 2-3 times considerably increases the chance that people will be able to remember it later and, subsequently, take action. However, when people hear the same ad too many times, they can become annoyed and stop paying attention. Thus, the preferred frequency of ad play can vary depending on the campaign objective. For example, in some cases advertiser may prefer to have a preferred frequency of 3. However, in some cases, e.g., branding campaigns, a higher frequency value in the range of 3-7 can be desirable.

In an advertising campaign, the average campaign frequency (i.e., the average number of ad play per listener) can be calculated based on the number of advertising spots allocated. For example, suppose that the weekday morning drive (6 a.m.-10 a.m.) spots for a radio station KROQ have a gross AQH of 10,000 listeners; and that the weekday afternoon drive (3 p.m.-7 p.m.) spots for a radio station KISS also have a gross AQH of 10,000 listeners. Assuming that there is no overlap in demographics between the two radio stations, if an advertising campaign books 10 of the weekday morning drive spots on KROQ and 20 of the 5 p.m. weekday afternoon drive spots on KISS, the average campaign frequency will be 15.

The conceptual diagram of FIG. 2 further shows an advertiser 230 who is interested in increasing its revenue by launching an advertising campaign 232. The advertiser 230 can define a marketing objective for the advertising campaign 232. For example, the objectives can be to increase awareness of the advertiser or the advertiser's product. Additionally, the marketing objectives can be to drive sales for a specific promotion, holiday, or event. Thus, the advertiser 230 can specify various criteria for the advertising campaign 232 in order to achieve the marketing objective.

As an example, the advertiser 230 can specify a target audience 234 for the advertising campaign 232. For example, suppose that the advertising campaign 232 is a radio advertising campaign; specifying the target audience 234 can include targeting by location, gender, age, station the audience listens to, and drive time/time of day the audience might be listening. Additionally, the advertiser 230 can interface with and communicatively couple to the advertising intermediary 220. For example, based on the demographics information of the target audience 234 for the advertising campaign 232, a target AQH can be calculated by the advertising intermediary 220 using the gross AQH number described above.

For instance, suppose that the gross AQH for an advertising spot is 10,000 listeners, which means that on average 10,000 listeners (ages 12 and above) listen to the broadcast in a 15-minute time period. Further, suppose that the target audience is only male listeners who are between the ages of 24 and 40. Based on this information and the gross AQH (μ_{G}) number, a target AQH (μ_{T}) number, can be, e.g., 2,000 listeners that fit the demographics profile. Additionally, a spot efficiency 228 (η) for the targeted demographics profile can be calculated using the following equation.

$$η = \frac{{μ}_{T}}{{μ}_{G}}$$

Thus, the spot efficiency 228 measures the percentage of listeners for an advertising spot that meets the targeted demographics profile.

Given a rate card price (X_{R}) and a target AQH (μ_{T}) number for the spot, a target CPM (X_{MT}) for an advertising spot can be calculated using the following equation.

$${X}_{MT} = ( \frac{{X}_{R}}{{μ}_{T}} ) \times 1 , 000$$

Since the target AQH is a percentage (depending on the targeted demographic profile) of the gross AQH, the target CPM is always greater than or equal to the gross CPM for an advertising spot. For example, if the rate card price for an advertising spot is $10 and the gross AQH is 10,000 listeners, while the target AQH is 2,000 listeners, then the gross CPM is $1 and the target CPM is $5 for the advertising spot.

In addition to the target audience 234, the advertiser 230 can also specify campaign caps 236 for the advertising campaign 232. Campaign caps 236 can include, e.g., number of impressions, daily budget, weekly budget, and total campaign budget. The advertiser 230 can further specify a target reach 238 for the advertising campaign 204. As noted above, reach can represent the number of unique persons who perceived (e.g., heard or seen) the ad. For example, the advertiser 230 can specify a target reach 238 of 10,000 people for an advertising campaign. Additionally, the advertiser 230 can specify a target frequency 240 for the advertising campaign 204. As described above, frequency can represent the average number of times that a person has perceived the ad. As will be described in more detail below, the frequency goals can be incorporating into the spot selection process (e.g., an auction process) for an advertising campaign.

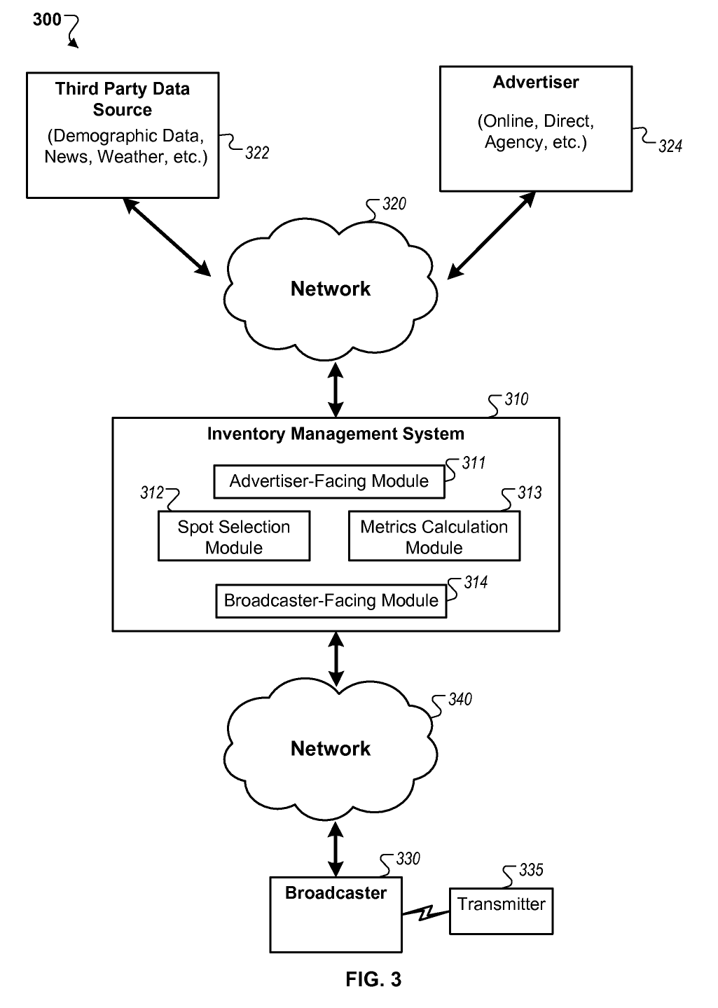

FIG. 3 is a schematic diagram of an example system 300 for booking an advertising campaign based, e.g., on reach and frequency goals. The methods, processes, engines, apparatus, computer program products, systems and the like discussed below can be applicable to audio advertising environment and other communication environments including broadcast television, cable television, satellite television, Internet communication systems (including Internet radio and Internet television), and other communication environments.

Ads can be inventoried and categorized for system 300 in several ways, e.g., by keyword, price, vendor, last played, and the like. In some implementations, the broadcasters can use the ad inventory information and other data to schedule current ads, and reschedule new ads that may be more suitable (e.g., suitable in terms of content, price, or other criteria) in a particular time slot. For example, a broadcaster can sell a last-minute ad at a higher price (e.g., higher CPM) than other previously received ads.

As shown in FIG. 3, system 300 includes an ad inventory management system (IMS) 310, which can include an advertiser-facing module 311, an spot selection module 312, a metric calculation module 313, and a broadcaster-facing module 314. The advertiser-facing module 311 can interface with and communicatively couple to third-party data source 322 and advertiser 324 via a network 320. In this example, the network 320 is the Internet. In other implementations, the network 320 can include any network, such as a local area network, metropolitan area network, wide area network, a wired or wireless network, a private network, or a virtual private network.

The spot selection module 312 can be used by the IMS 310 to, e.g., book an advertising campaign for the advertiser 324. Additionally, ad booking module 312 can allocate advertising spots that most closely match with the advertiser's campaign criteria (e.g., target reach and frequency) for an advertising campaign. The metrics calculation module 313 can be used by the IMS to, e.g., calculate the spot efficiency for an advertising spot and campaign reach and frequency for an advertising campaign. The broadcaster-facing module 314 can interface via network 340 with broadcaster 330, which can be, e.g., a radio station. In one implementation, network 340 can be a similar network as network 320. The broadcaster 330 can deliver broadcast content to the audience via transmitter 335.

The third-party data source 322 can include any database, data mart, intermediary, or other data source that provides data of interest to the advertiser 324 relevant to the scheduling of advertisements. For example, third-party data can be Arbitron ratings and demographic breakdowns for each station in a broadcast network. Further, such third-party data can be of use to an advertiser 324 in deciding what amount it would be willing to pay to run an advertising campaign on a given station. In addition, third-party data can be of the form of event data such as the weather forecast, current weather conditions, or news events such as stock prices, sports scores, data from a syndicated data feed, such as a feed in the Really Simple Syndication (RSS) format, or any other data relevant to an advertiser's desire to play an ad.

The advertiser 324 can be, e.g., an online advertiser, a direct sales advertiser, an advertising broker and an advertising agency. In some implementations, the advertiser 324 can access the IMS 310 via a connection to the Internet 320. The connection can be made using the Internet Protocol Suite (Transmission Control Protocol and the Internet Protocol (TCP/IP)) over various types of connections. The IMS 310 can have a unique Internet address allowing advertiser 324 to identify the IMS 310. In one implementation, advertiser 324 can have an account with the IMS 310 and be charged a fee for use of the IMS 310. In another implementation, advertiser 324 can access the IMS 310 free of charge.

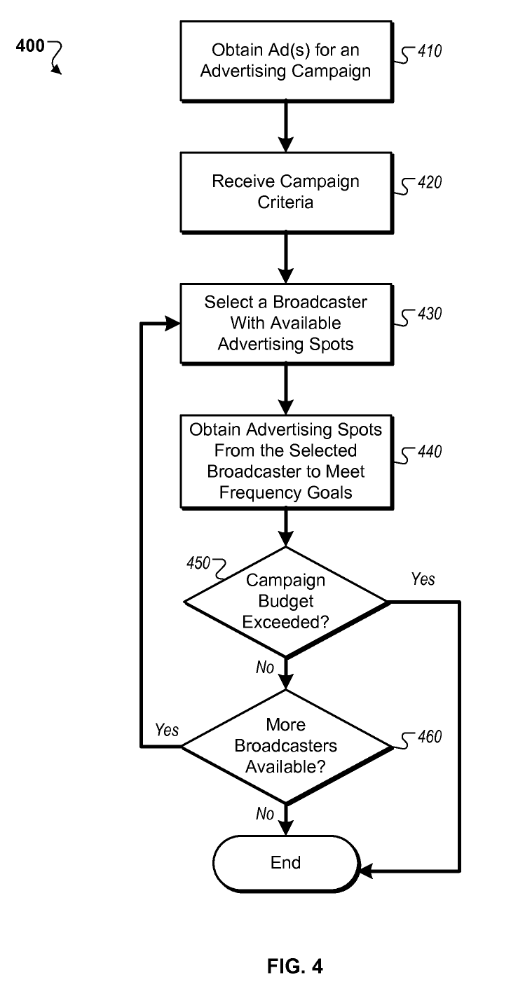

FIG. 4 is a flow chart illustrating an example frequency-aware spot selection process 400 for booking an advertising campaign. In general, the illustrated process 400 involves two general steps. First, process 400 selects a content distributor (e.g., radio stations) where enough spots are available over the coming time period (e.g., a week) to meet the frequency goals for a given campaign. During this first step, distributions for markets and station rankers can also be considered in a weighted optimization calculation. Second, process 400 selects specific spots on the previously selected distribution network (e.g., station). During this second step, distributions for dayparts and day of week can be considered in a weighted optimization calculation. In certain implementations, because the industry norm calculates frequency based on a broadcast week (e.g., Monday to Sunday time period) while a typical spot selection process (e.g., an auction) can run daily or even hourly, process 400 is built upon a forecast of the supply of inventory from broadcasters. Thus, process 400 can be built on the foundation of the supply forecaster.

In addition to campaign budget, in some implementations four other campaign criteria can be used to select advertising spots for a traditional media (e.g. radio and television) advertising campaign. These four campaign criteria or constraints can be:

1. Overall impression delivery, or total number of impressions;

2. Distribution of impressions (across markets, ranker of station, dayparts, days of week);

3. Reach and frequency; and

4. Cost (CPM).

In one implementation, the campaign budget can be used as a hard constraint and the above four criteria can be used as soft constraints in the advertising spot selection process. Other combinations of hard and soft constraints can be selected.

In one implementation, the spot selection process can take into account the first two criteria (total number of impressions and distribution of impressions) balanced against cost (CPM) when deciding which spots to select (e.g., bid on) for a campaign. For example, in some implementations, the distribution metrics (δ) are weighted as far more important than cost (X) (a “distribution at any cost” model), as long as the campaign budget is not exceeded. Such implementations are illustrated by the following equation for an overall metric (X_{O}) for a given spot, where a second weighting (w₂) is much greater than a first weighting (w₁) (i.e., w₂>>w₁).

X_{O}=(w₁×X)+(w₂×δ)

In one implementation, the spot selection process chooses the next spot based on a candidate spot that produces the best distribution of impressions (across the multi-dimensional market/tier/daypart/day-of-week space). In some implementations, among all the candidate spots that would have the same distribution, the spot selection process chooses the one with the lowest cost. The spot selection approach, then, is distribution at any cost because, as noted above, the distribution criterion is given more weight than the cost criterion.

In another implementation, the spot selection process (e.g., a “frequency at any cost” model) can take into account frequency goals into the equation along with overall delivery and distributions to be balanced against cost. For example, the frequency goal for the advertising campaign can be incorporated into the cost metric as outlined below. The station cost (X_{S}) can be defined with the following equation, where the satisfaction cost (X_{A}) is the cost for enough additional spots to satisfy the minimum frequency target for the station for a given campaign and the impressions (ω) are the total impressions for all spots in a given time period (e.g., a week) on this station (both already played and additional spots for a given campaign).

$${X}_{S} = \frac{{X}_{A}}{ω}$$

Thus, frequency can depend on an accumulation of spots on a particular station over the course of a particular time period (e.g., week). In other words, frequency can become a period (e.g., weekly) metric and can be a metric that builds most quickly if spots are already placed on the same medium (e.g., station). The equation above embeds frequency into the cost (CPM) calculation because the numerator includes the cost only for the additional spots required to hit minimum frequency while the denominator includes the impressions for all spots (both already played and additional required). In this manner, the cost equation inherently favors distribution mediums (e.g., stations) where a given campaign has played spots already thereby creating a frequency-aware spot selection process.

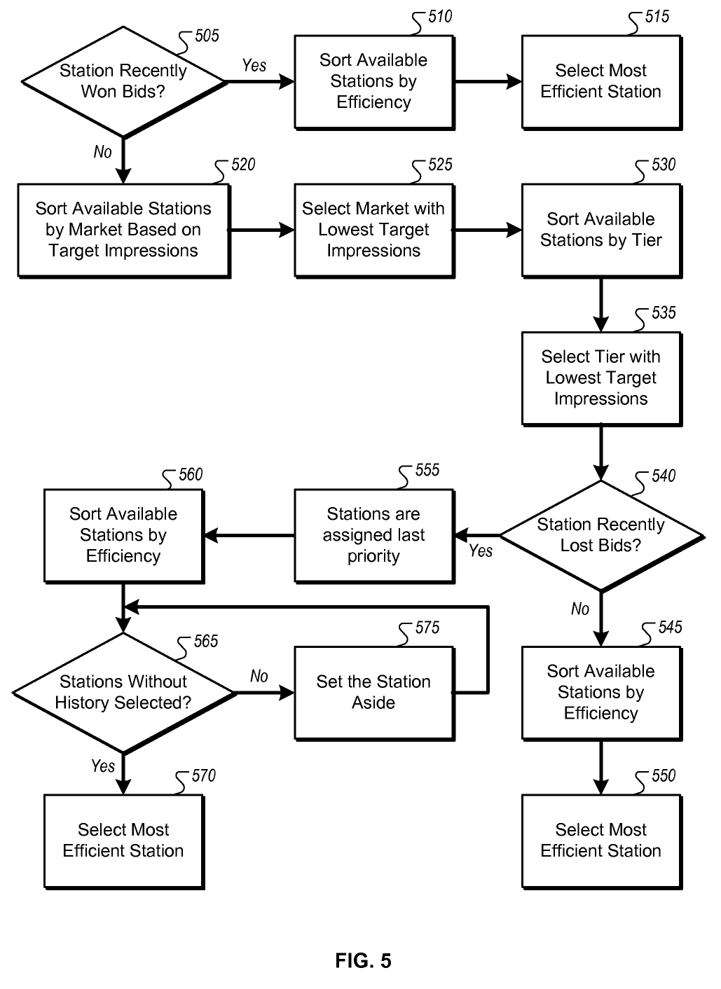

FIG. 5 is a flow chart illustrating an example process 500 for selecting broadcasters based on campaign frequency goals. The example process 500 can be performed by, e.g., the spot selection module 312 described above. At 505, the process determines whether the station has recently won bids. If yes, the station is categorized in a “preferred station” group, and, at 510, process 500 sorts all the available stations in the “preferred station” group according to the station efficiency. At 515, process 500 selects the most efficient station first to fill advertising spots. In this manner, the stations that have already won advertising spots can be assigned top priority in the spot selection process and a frequency-aware spot selection process can be achieved.

On the other hand, if a station has not recently won any bids in an auction process the station can be categorized into other groups based on market and tier distribution. For example, at 520, process 500 sorts all the available stations that have not recently won bids by market distribution based on target impressions. At 525, process 500 selects the market with the lowest target impressions. At 530, process 500 sorts the available stations in this group further by tier distribution. At 535, process 500 selects the station with a tier associated with the lowest target impressions. Once the market-tier groups have been categorized based on the steps described above, the stations within each market-tier group can be further categorized based on its recent bidding history.

For example, at 540, the process determines whether a station has recently lost bids in an auction process. If the station has not recently lost bids (i.e., the station has no recent bidding history), the station is assign a priority and, at 545, the process sorts all the available stations in this group by station efficiency. At 550, process 500 selects the most efficient station within this group for filling advertising spots. On the other hand, if a station has recently lost bids, at 555, the station is assigned the last priority. At 560, the process sorts all the available stations in this group by station efficiency. At 565, process 500 determines whether all the stations without history (which have a higher priority than the stations in this “recently lost” group) have been selected. If all the stations without history have already been selected, at 570, the process selects the most efficient station within this group for filling advertising spots. If, however, not all the stations without history have been selected, at 575, process 500 sets the station in the “recently lost” group and then repeats at 565 and waits until all the stations without history have been selected.

As an example, the spot selection process can initially select stations with enough available advertising spots to meet the frequency goals for a given campaign, while taking into account market and tier (station ranking) weightings. In this example, the spot selection process can first select stations that have the highest chances of achieving the campaign's frequency goals. In some implementations, the spot selection process can also categorize the distribution mediums (e.g., stations) into various groups based on market and tier distribution. In some implementations, all the stations that meet the campaign criteria can be categorized into one of these groups. Further, certain stations on which the campaign has “recently won” spots can be categorized as “preferred stations” because the campaign has the highest chance of obtaining advertising spots on stations on which it has won recently. In some implementations, the spot selection process can first select stations from this “preferred station” group, and only after there are no more stations to pick from this group does it move to other groups.

In order to decide on which of the remaining groups to get the stations from, in some implementations the spot selection process first picks the market that is most under delivered in terms of impressions. The process can use the weighting and the current impressions delivered in each market to determine under served status. In some implementations, the spot selection process can select stations from a market with the lowest total number of target impressions. After prioritizing based on the market distribution, the spot selection process can then pick the station ranking or tier that is most under delivered in that market. Thus, the group that represents the picked market and tier is the group from which the next station is selected.

Based on the assumption that past performance is a good indicator of success, in some implementations the spot selection process sorts the stations within each group by whether the campaign has recently bid on the station and lost, or has no recent history. In some implementations, when picking a station from a given group (other than the preferred stations group), priority can be assigned to stations that have no history over stations where the campaign has lost recently. Additionally, in some implementations, within each category—recently lost and no history—the stations can be sorted by efficiency, i.e. target CPM.

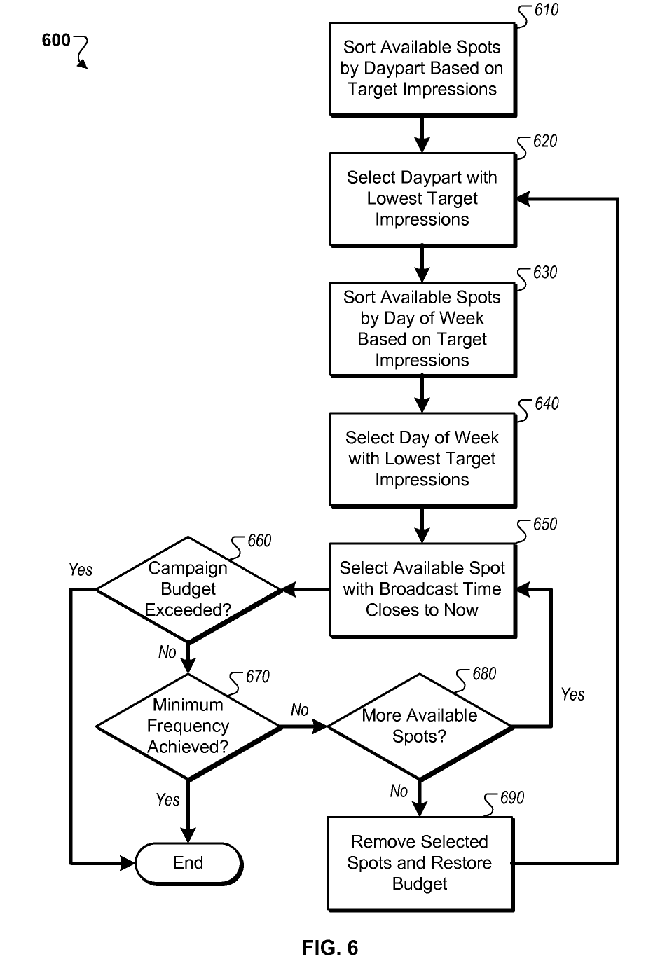

FIG. 6 is a flow chart illustrating an example process 600 for obtaining advertising spots for a selected broadcaster based on campaign frequency goals. The example process 600 can be performed by, e.g., the spot selection module 312 described above. At 610, process 600 sorts all the available spots for the selected station by daypart based on target impressions. At 620, process 600 selects the daypart with the lowest target impressions. At 630, the process sorts available spots by day-of-week based on target impressions. At 640, process 600 selects the day-of-week with the lowest target impressions. At 650, process 600 selects available spots with broadcast time closes to the next auction time. At 660, process 600 determines if campaign budget has been exceeded. If budget is spent, process 600 ends because, as noted above, campaign budget is treated as a hard constraint.

On the other hand, if budget is not spent, process 600, at 670, determines if minimum frequency is achieved. If minimum frequency is achieved for a given station, which means enough advertising spots have been selected from this station, process 600 ends. On the other hand, if minimum frequency is not achieved, process 600 determines, at 680, whether more spots are available from this station. If yes, process 600 repeats at step 650. If there are no more spots from this station and the minimum frequency is not achieved, at 690, process 600 removes all the previously selected spots from this station and restores the campaign budget, and moves on to the next station on the list.

Once a station has been selected, the spot selection process then proceeds to select spots on that station to bid on. Additionally, for each selected station, the spot selection process can select available advertising spots based, for example, on daypart and day-of-the-week weighting. In some implementations, the selection objective is optimized to achieve the minimum desired frequency for any running time period (e.g., a week). For example, in one example scenario if one takes any consecutive 7 days of the campaign on a station, the campaign will have a frequency in the frequency range. When this is not possible, the selection process makes compromises to get desired frequency on some periods of time.

Other alternatives of the frequency-aware spot selection process can include, e.g.:

1. Instead of embedding frequency goals into the cost term, a third “frequency” term can be added to the optimization equation in addition to the cost and distribution terms; or

2. implement a weekly or “rolling weekly” auction process.

Approach #1 has at least one primary drawback in that it can be computationally expensive. Approach #2 involves auctioning inventory in one week blocks and can have at least two primary drawbacks. For example, campaigns that come in part way through the week would not have access to the full amount of inventory even if their bid is higher, thus violating one of the principles of an auction process. In addition, the accuracy of the supply forecast given the variability of supply of available spots from broadcasters can be limited. Thus, an auction based on forecasting a week ahead can be inherently less accurate than an auction based on available spots in hand for the near future (e.g., same day or tomorrow). On the other hand, if the contracts with the broadcasters were for a guaranteed supply throughout the week, then this drawback may not apply.

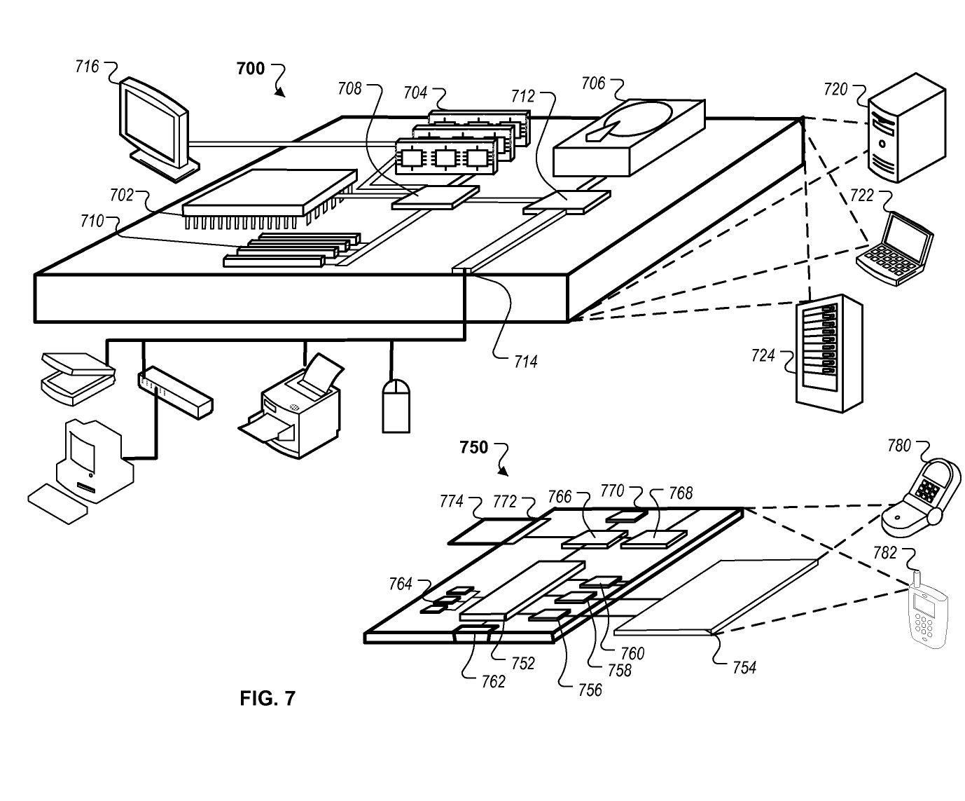

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the described embodiments. Accordingly, other embodiments are within the scope of the following claims.

What is claimed is:

1. A computer-implemented method comprising:
receiving advertising campaign characteristics including a minimum frequency target for an advertising campaign;
selecting, based on the received advertising campaign characteristics, a station having one or more advertising spots available;
determining, based on the one or more advertising spots, whether the minimum frequency target is attainable for the selected station; and
making an offer to the selected station, in response to the determination, to obtain advertising for the advertising campaign.

2. The computer-implemented method of claim 1, wherein the received advertising campaign characteristics implicitly include the minimum frequency target.

3. The computer-implemented method of claim 1, wherein the received advertising campaign characteristics comprise information regarding the advertising campaign having recently advertised on the station.

4. The computer-implemented method of claim 1, wherein the selected station comprises a radio station.

5. The computer-implemented method of claim 1, wherein the selected station comprises a television station.

6. The computer-implemented method of claim 1, wherein selecting comprises selecting the station that serves an underserved market and station-tier.

7. The computer-implemented method of claim 1, wherein determining comprises determining whether the minimum frequency target is attainable over a seven-day period.

8. The computer-implemented method of claim 7, wherein determining comprises determining based on forecasted advertising spots.

9. The computer-implemented method of claim 1, further comprising:
choosing, based on daypart and day of the week criteria, and proximity to present time, on which of the one or more advertising spots to make the offer.

10. A computing device comprising a computer program product stored on a computer readable medium, the stored computer program product including executable instructions causing the computing device to perform functions comprising:
receiving advertising campaign characteristics including a minimum frequency target for an advertising campaign;
selecting, based on the received advertising campaign characteristics, a station having one or more advertising spots available;
determining, based on the one or more advertising spots, whether the minimum frequency target is attainable for the selected station; and
making an offer to the selected station, in response to the determination, to obtain advertising for the advertising campaign.

11. The stored computer program product of claim 11, wherein the received advertising campaign characteristics implicitly include the minimum frequency target.

12. The stored computer program product of claim 11, wherein the received advertising campaign characteristics comprise information regarding the advertising campaign having recently advertised on the station.

13. The stored computer program product of claim 11, wherein the selected station comprises a television station.

14. The stored computer program product of claim 11, wherein the selected station comprises a radio station.

15. The stored computer program product of claim 11, wherein selecting comprises selecting the station that serves an underserved market and station-tier.

16. The stored computer program product of claim 11, wherein determining comprises determining whether the minimum frequency target is attainable over a seven-day period.

17. The stored computer program product of claim 16, wherein determining comprises determining based on forecasted advertising spots.

18. The stored computer program product of claim 11, further including executable instructions causing the computing device to perform functions comprising:
choosing, based on daypart and day of the week criteria, and proximity to present time, on which of the one or more advertising spots to make the offer.

19. A system comprising:
an advertiser-facing module configured to interface with an advertiser and to receive advertising campaign characteristics, including a minimum frequency target, for an advertising campaign;
means for selecting, using the advertising campaign characteristics, a broadcast station from available broadcast stations;
means for determining, using available advertising spots of the broadcast station, whether the minimum frequency target is attainable by the advertising campaign on the broadcast station; and
means for submitting an offer, on behalf of the advertising campaign, to the broadcast station for one or more of the available advertising spots.

20. The system of claim 19, wherein the broadcast station is a television station, further comprising:
means for choosing, using at least daypart and day of the week criteria, on which of the available advertising spots to make the offer.
